(19) United States
(12) Patent Application Publication
(10) Pub. No.: US 2026/0151656 A1
(43) Pub. Date: Jun. 4, 2026

(54) FOREST FIRE POD AND RACK FRAME

(71) Applicant: Greg Raiford, Fort Lauderdale, FL (US)

(72) Inventor: Greg Raiford, Fort Lauderdale, FL (US)

(21) Appl. No.: 18/967,848

(22) Filed: Dec. 4, 2024

(51) Int. Cl. A62C 3/02

(52) U.S. Cl. CPC A62C 3/025

(57) ABSTRACT

A forest fire pod system including a rack frame configured to hold a plurality of forest fire pods, the rack frame having a plurality of rollers to facilitate loading and unloading of the forest fire pods, wherein each forest fire pod includes a multi-layered shell including a plurality of bio-degradable and water resistant layers, a fill port to capture an amount of fire retardant material, and a fill port plug configured to seal the fill port and enable the forest fire pods to be stored for transit.

### TECHNICAL FIELD

Example embodiments disclosed herein relate generally to a fire-fighting system, and more particularly to one or more forest fire pods and a rack frame for storing and deploying the forest fire pods.

### SUMMARY

A brief summary of various example embodiments is presented below. Some simplifications and omissions may be made in the following summary, which is intended to highlight and introduce some aspects of the various example embodiments, but not to limit the scope of the invention. Detailed descriptions of example embodiments adequate to allow those of ordinary skill in the art to make and use the inventive concepts will follow in later sections.

Embodiments include A forest fire pod system, including a rack frame configured to hold a plurality of forest fire pods, the rack frame having a plurality of rollers to facilitate loading and unloading of the forest fire pods, wherein each forest fire pod includes, a multi-layered shell including a plurality of bio-degradable and water resistant layers, a fill port to capture an amount of fire retardant material; and a fill port plug configured to seal the fill port and enable the forest fire pods to be stored for transit.

The multi-layered shell may include layers including a polyvinyl alcohol polymer and a bio-degradable resin.

The fill port may have a substantially circular cross-section.

The forest fire pods may be hexagonal shaped.

The plurality of rollers includes a plurality of side gravity conveyor rollers disposed at sides of the rack frame.

The plurality of rollers include a plurality of bottom gravity conveyor rollers disposed adjacent a bottom of the rack frame. The plurality of bottom gravity conveyor rollers are disposed on a bottom conveyor sled, wherein the bottom conveyor sled is configured to receive and deploy the forest fighting pods.

The rack frame includes a front rack door that forms an entry point to allow the forest fire pods to be accessed during service, maintenance, and deploying of the forest fire pods

### BRIEF DESCRIPTION OF THE DRAWINGS

Additional objects and features of the invention will be more readily apparent from the following detailed description and appended claims when taken in conjunction with the drawings. Although several example embodiments are illustrated and described, like reference numerals identify like parts in each of the figures, in which:

FIG. 1 illustrates a forest fire pod in accordance with embodiments described herein;

FIG. 2 illustrates a cutaway view of a forest fire pod in accordance with the embodiment of FIG. 1;

FIG. 3 illustrates a rack frame in accordance with embodiments described herein;

FIG. 4 illustrates a front view of a rack frame in accordance with FIG. 3;

FIG. 5 illustrates a bottom view of a rack frame in accordance with FIG. 3;

FIG. 6 illustrates a back view of a rack frame in accordance with FIG. 3; and

FIG. 7 illustrates an internal view of a rack frame and forest fire pods in accordance with embodiments described herein.

### DETAILED DESCRIPTION

It should be understood that the figures are merely schematic and are not drawn to scale. It should also be understood that the same reference numerals are used throughout the figures to indicate the same or similar parts.

The descriptions and drawings illustrate the principles of various example embodiments. It will thus be appreciated that those skilled in the art will be able to devise various arrangements that, although not explicitly described or illustrated herein, embody the principles of the invention and are included within its scope. Furthermore, all examples recited herein are principally intended expressly to be for pedagogical purposes to aid the reader in understanding the principles of the invention and the concepts contributed by the inventor(s) to furthering the art and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various example embodiments described herein are not necessarily mutually exclusive, as some example embodiments can be combined with one or more other example embodiments to form new example embodiments. Descriptors such as “first,” “second,” “third,” etc., are not meant to limit the order of elements discussed, are used to distinguish one element from the next, and are generally interchangeable. Values such as maximum or minimum may be predetermined and set to different values based on the application.

Although the various exemplary embodiments have been described in detail with particular reference to certain exemplary aspects thereof, it should be understood that the invention is capable of other example embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

Traditional fire-fighting helicopters and aircraft water tankers do not have this advantage of making a second pass over a forest fire. Once they've released all their water or fire retardant on a forest fire, they must immediately return to base to be refilled. The ability to stay on the front line of fighting a forest fire greatly increases the chance of controlling and extinguishing a forest fire. Those familiar with forest fires that when forest fires start in remote forest areas with no roads or firefighting equipment available, the forest fire burns out of control and becomes the most destructive disasters to federal forest, private, county and state property, which includes loss of human life.

The forest fire pods described herein are configured to increase response time of combatting forest fires, and to allow emergency aircrafts to remain on station longer than current firefighting aircrafts. “On station” is a term used in military and emergency aviation, referring to the time when an aircraft is in its designated operational area, ready and available to perform its assigned duties. Being “on station” refers to the aircraft being in the correct position and ready to engage in its operational role.

The forest fire pods, also called fire-fighting pods, may be integrated within current fire-fighting schemes. The fire-fighting pods may be a first or early response until later firefighting equipment and personnel becomes on station at the fire. One aspect of accomplishing this task includes forest fire pods being a self-contained unit filled with either water or fire-retardant liquid.

Another feature of forest fire pods is that they allow firefighting aircrafts to be fully filled, loaded with water or fire retardant liquids ready to take off year round, seven days a week. Every second counts when trying to maintain and control a forest fire before it burns out of control.

Forest fire pods described herein are designed to provide swift deployment of firefighting aircrafts within fifteen to thirty minutes after an alert has been received by firefighting units. The forest fire pods are intended to supplement and work in conjunction with current methods of fighting forest fires with helicopters, aircraft water tankers, ground equipment, and firefighting personnel.

One goal is to incorporate the forest fire pods into standard operating procedures for fighting forest fires. This new piece of firefighting equipment is intended to slow the progression of a forest fire until firefighting equipment has arrived on scene. Forest fire pods are intended to be the first line of aerial defense for forest fires in remote locations where there are no roads, residential, or commercial development.

Forest fire pods described herein are self-contained units that are configured to be dropped from the cargo bay of a firefighting aircraft over a targeted fire. These forest fire pods, when released from its rack frame need no mechanical or electrical source to deploy, arm or detonate them. Due to the weight of each forest fire pod, gravity will increase their rapid descent and will split open when contact is made with tree branches or the ground.

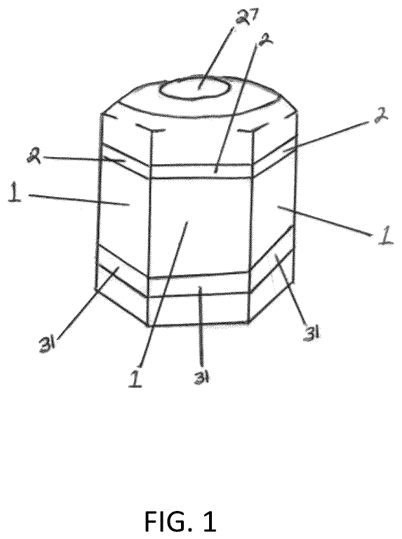

FIG. 1 illustrates a forest fire pod 100 in accordance with embodiments described herein. The forest fire pod 100 provides a quick state of readiness all year round to combat forest fires at a moment's notice when rapid deployment is critical to controlling and combatting forest fires.

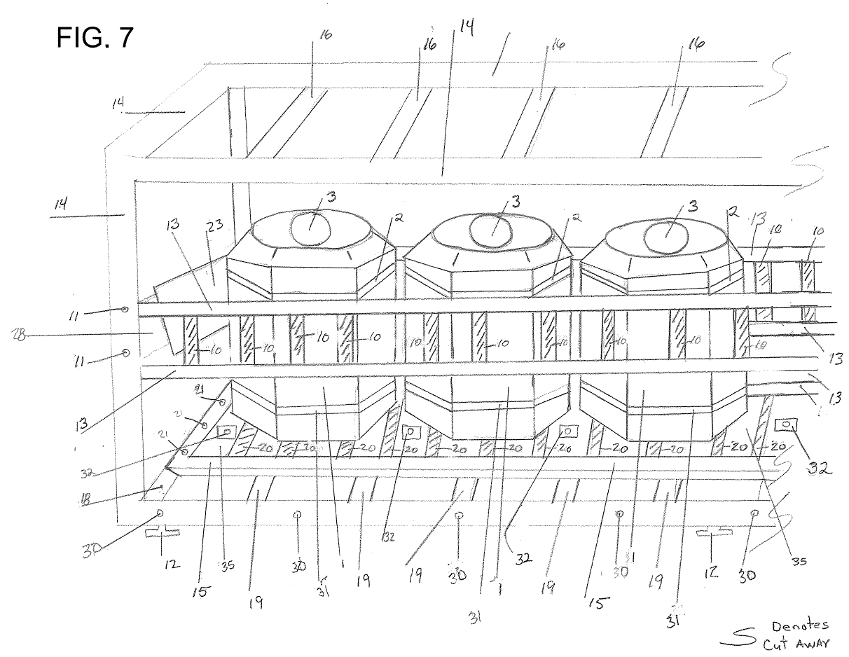

As illustrated in FIGS. 1, 2 and 7, the forest fire pod 100 shall be constructed of a bio-degradable and or eco-friendly material.

The construction of one or a plurality of forest fire pods 100 is made possible through the use of multiple materials. Because the forest fire pods 100 are large units that will hold hundreds of gallons of liquid, they have to be able to hold the stress and weight for long periods of time. To help aid in their construction, an alternating layered technique is used.

One source of material for forest fire pods 100 will be cardboard and other bio-degradable material. The cardboard may be obtained from local and regional businesses committed to recycling reusable material. As illustrated in FIG. 1, the forest fire pod 100 may be formed into a hexagon shape of sufficient thickness to maintain its shape with and without fill material disposed therein.

The forest fire pod 100 has a multi-layered shell 1 that may be made of recycled cardboard and reinforced with a bio-degradable resin in various layers of the forest fire pods 100 for added strength, durability and stability. The added resin into the layers of the forest fire pod 100 will allow the forest fire pod 100 to maintain its shape when filled with water, firefighting retardant, or any other liquid material.

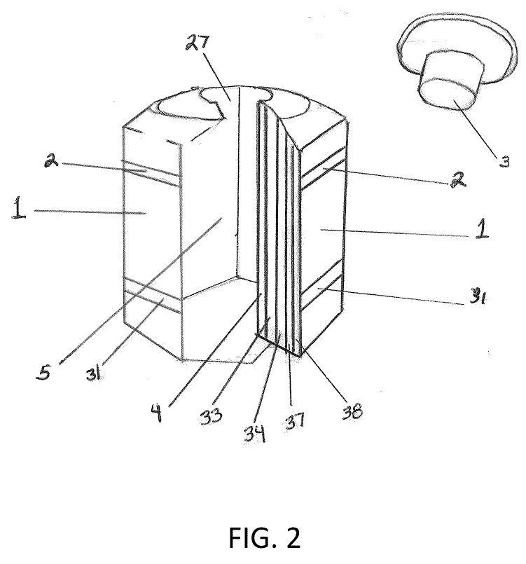

As illustrated in FIGS. 1 and 2, forest fire pods 100 as described herein have five layers 4, 33, 34, 37 and 38 that make up the multi-layered shell 1 of the forest fire pods 100 and surround a liquid chamber 5. The multi-layered shell 1 is a multi-layered water-resistant liner.

A first layer of the multi-layered shell 1 is the inner liner 4. The inner liner 4 is a thick layer of a water-resistant material, such as polyvinyl alcohol polymer. The inner liner 4 surrounds a liquid chamber 5 that is configured to store the water or firefighting retardant. Inner liner 4 prevents liquids in the liquid chamber 5 from leaking through the multi-layered shell 1. A thickness of the inner liner 4 may be on the order of one-quarter inch to one inch thick.

Because forest fire pods 100 are made with the water-resistant multi-layered shell 1, this feature allows the forest fire pods 100 to have a significant storage shelf life when completely filled. The water-resistant multi-layered shell 1 makes it possible for the forest fire pods 100 to be stored up to two years or longer until they are needed to fight a forest fire.

The water-resistant multi-layered shell 1 also allows the forest fire pods 100 to remain on an aircraft for long lengths of time during peak forest fire seasons when the aircraft is on the ground. This feature saves precious time that allows an aircraft to remain on standby readiness 24/7 hours a day ready to take off at a moment's notice.

The inside of the inner liner 4 facing the liquid chamber 5 is made of the water-resistant material that is configured to prevent liquids stored in the liquid chamber 5 from leaking through the shell 1 of the forest fire pod 100.

The water-resistant multi-layered shell 1 includes a second layer 33 that is made of bio-woven material. The bio-woven material of the second layer 33 is infused with an epoxy resin for strength and is coated with a thick layer of a polyvinyl alcohol polymer to add backup protection to the inner liner 4. This second layer 33 adds another barrier of leak prevention and core strength to the forest fire pods multi-layered shell. A thickness of the second layer 33 may be on the order of one-quarter inch to one inch thick.

Located next is a third layer 34 that is made of recycled cardboard designed to help the forest fire pod 100 maintain its hexagon shape. The third layer 34 is infused with a biodegradable resin for added strength and aids the forest fire pods to maintain its shape when filled with liquids. A thickness of the third layer 34 may be on the order of one-quarter inch to one inch thick.

The fourth layer 37 is a durable heavy-duty unwaxed eco-conscious construction paper infused with bio-degradable resin for strength and coated with a thick layer of a water-resistant material to prevent leakage. A thickness of the fourth layer 37 may be on the order of one-quarter inch to one inch thick.

The fifth layer 38 is a non-woven bio-degradable fabric with a cardboard exterior infused with biodegradable resin and coated with a thick layer of a water-resistant material After all layers are affixed to each other they are pressed together into a hexagon shape that forms the forest fire pod. A thickness of the fifth layer 38 may be on the order of one-quarter inch to one inch thick.

The fifth layer 38 of non-woven bio-degradable fabric with the cardboard exterior may also be called an outer layer, or a fifth outer layer. After each layer has been affixed they are pressed into a hexagon shape using a hexagon frame (not illustrated) to form the forest fire pod 1. The materials are rigid and maintain the hexagon shape when not filled with water or fire retardent. The forest fire pods 100 should be kept in the rack frame (described herein) when stored in an un-filled state in order to maintain the integrity of the multi-layered structure.

As described herein, each of the several forest fire pods 100 to be stored and/or deployed may be made of a cardboard and or similar material. To provide added strength, durability and stability to the multi-layered shell 1 of the forest fire pods 100, bio-degradable are added to various layers. The bio-degradable resins include biopolymers or bioplastics to further reinforce the cardboard and other material. One example shape of the forest fire pods 100 is a hexagon, but embodiments are not limited thereto. Forest fire pods may be made square, rectangular, circular, triangular, pentagonal, or other geometric shapes as contemplated by one skilled in the art.

During the construction and manufacturing phase, the fifth layer 38 made of non-woven bio-degradable fabric may be infused with dormant grass seeds and or tree seeds. This infusion process will allow burned areas of a forest or affected area to be quickly seeded with new plant growth to control and minimize soil erosion and help prevent land slides due to lack of trees and grass.

Alternatively, dormant grass seeds, tree seeds, or the like may be added to the liquid chamber 5 before or after the water or fire retardant liquid is loaded into the forest fire pods 100. Addition of the seeds allows areas burned by the fire to be quickly reseeded with new plant growth to control and minimize soil erosion.

Because the forest fire pods are constructed of bio-degradable material, upon impact, once the forest fire pods 100 burst or make contact with the ground, the structure will start to decay. No further action is required by fire fighting personnel to remove any portion of the fire fighting pods 100 from a drop point.

Dimensions of the forest fire pod may vary depending on the type of aircraft to be used and space available. A variety of aerial firefighting aircraft are used globally to combat forest and other wildfires, each offering distinct capabilities in terms of payload and water capacity. For example, the Boeing 747 Supertanker, one of the largest aerial firefighting planes, is a converted Boeing 747 airliner that can carry up to 19,200 gallons of water or fire retardant, with a water weight of approximately 160,000 pounds. Another widely used aircraft is the Lockheed C-130 Hercules, equipped with the Modular Airborne FireFighting System (MAFFS), which is a versatile military transport aircraft capable of holding 3,000 gallons of water or fire retardant, with a water weight of around 25,000 pounds. The McDonnell Douglas DC-10 Air Tanker is another large firefighting aircraft, with a payload capacity of 12,000 gallons of water or fire retardant and a water weight of approximately 100,000 pounds. For helicopter-based operations, the Sikorsky CH-53K King Stallion, one of the largest heavy-lift helicopters, can carry up to 2,400 gallons of water in a bucket, with a water weight of around 20,000 pounds. Similarly, the Erickson Air-Crane, specifically designed for aerial firefighting and often used in challenging terrain, can hold 2,650 gallons of water, with a water weight of approximately 22,105 pounds. These aircraft, and similar aircraft that have high maneuverability and can carry large loads, can be modified to fit the frames of the current invention.

Dimensions of the forest fire pod 100 may be somewhat large to be able to carry sufficient water or fire retardant material and make an impact on problem fires. For example, a hexagonal fire fighting pod could have a height of 8 feet, a diameter of 7 feet, and each side of the hexagonal base measures 3.5 feet in length has a volume of approximately 254.61 cubic feet, capable of holding around 1,904.63 gallons of water, with a corresponding water weight of approximately 15,884.58 pounds. Multiple forest fire pods 100 of this size could be used to fill up a portion of the one of the aircraft vessels. Depending on a size requested from a customer, the forest fire pods 100 described herein could be made of varying dimensions without taking away from the inventive ideas herein. For example, the forest fire pods could be made wider than they are taller, or made with a smaller volume than the above example, to fit a desired aircraft. Based on the dimensions of the forest fire pods 100, the rack frame and other components of the rack frame as discussed herein may be constructed to fit a plurality of forest fire pods 100 depending on a size of the space available on the aircraft.

As illustrated in FIG. 2, each forest fire pod 100 includes a fill port plug 3 that is configured to be inserted into a fill port 27. The fill port plug 3 is a single piece having two parts, a seal and a plug.

The fill port plug seal 3 ensures the forest fire pods 100 are securely sealed such that that no liquid spills from the fill ports 27. The fill port plug seal 3 is round in shape and coated with an epoxy glue such that when the fill port plug seal 3 is pushed into the opening of the fill port 27, a snug fit is established that prevents water and fire retardant material from being released from the forest fire pods 100. After water and fire retardant material (not illustrated) and the fill port plug seal 3 has been installed, the forest fire pod 100 is a fully self-contained, spill free unit.

After the forest fire pods 100 are formed into a hexagon or other suitable shape, they are set in a upright position. To ensure a forest fire pod 100 is positioned correctly for filling and storage, the fill port 27 must be positioned on top as illustrated by a fill port indicator 2 around the pod. The a fill port indicator band 2 may be a colored band made fluorescent orange, red, or other suitable color.

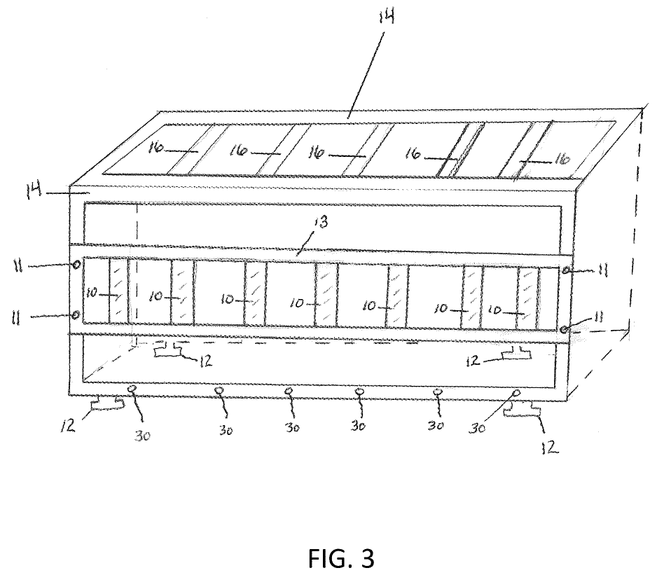

FIG. 3 illustrates a rack frame 14 in accordance with embodiments described herein.

In order to store the forest fire pods 100, a rack frame 14 is disclosed. The rack frame 14 serves as the mounting base for other forest fire pods 100. The rack frame 14 houses and aids in the deployment of the forest fire pods 100 from a cargo bay area of a firefighting aircraft, for example.

The rack frame 14 surrounding the forest fire pods 100 could be fabricated from a variety of materials depending on the specific operational desires and the like. One option is steel, particularly galvanized or stainless steel, which provides excellent strength and durability, allowing the rack frame 14 to support the weight of multiple forest fire pods 100. Steel is also highly resistant to both fire and heat, making it suitable for firefighting applications where the frame may be exposed to extreme temperatures. In addition, stainless steel is resistant to rust and corrosion, ensuring long-term durability, even in harsh environments. Steel offers the benefit of being cost-effective for large-scale structural frames.

Alternatively, the rack frame 14 could be constructed from aluminum, which is significantly lighter than steel while still maintaining sufficient strength to support the forest fire pods 100. Aluminum's natural corrosion resistance makes it ideal for prolonged exposure to water, and its heat resistance, though not as high as steel, is adequate for most firefighting scenarios. The lightweight nature of aluminum also makes it a suitable choice for mobile firefighting units, where ease of transportation is essential. For high-performance applications, titanium or carbon fiber can be used. Titanium offers an exceptional strength-to-weight ratio, is highly resistant to corrosion, and provides superior heat resistance, making it ideal for extreme firefighting conditions. Similarly, carbon fiber or composite materials provide a lightweight yet strong alternative, with excellent corrosion resistance and the ability to withstand moderate heat, although it may not perform as well as metals in the most extreme fire environments. These materials, while more expensive, offer significant advantages in terms of weight savings and strength, particularly for mobile or airborne firefighting systems.

The rack frame 14 is a central housing component that enables each forest fire pod 100 to operate properly, quickly and efficiently. The rack frame 14 is constructed of metal and designed to hold multiple forest fire pods 100 at one time. The rack frame 14 houses the forest fire pods during storage on an aircraft, the staging area, while filling, during maintenance and houses each forest fire pods when they are empty in a ready state to be filled with water or fire retardant material.

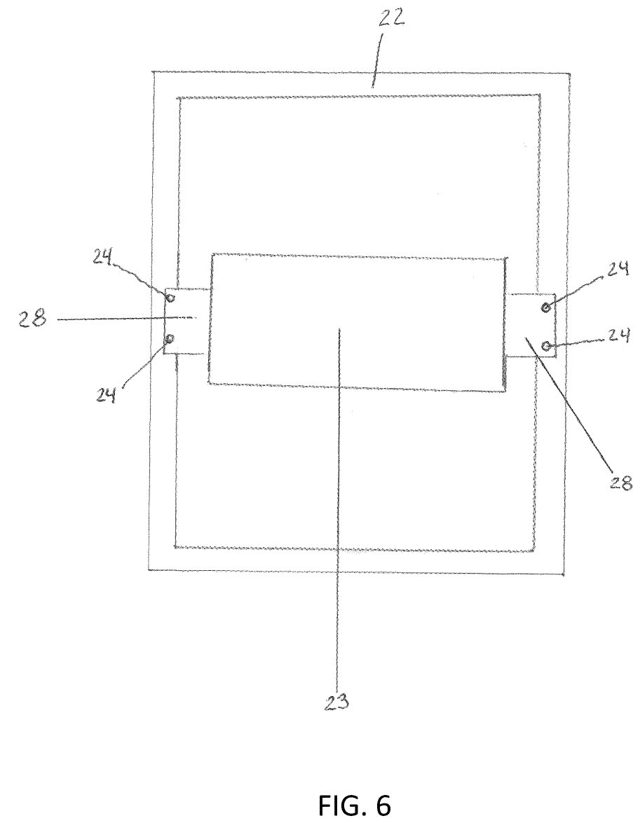

Other components included in the operation of the forest fire pods 100 use the rack frame 14 as a mounting base. Components include rack frame support braces 16, bottom conveyor support beams 19, bottom sled frame 18, bottom conveyor sled 15, bottom gravity conveyor rollers 20, side conveyor track frame 13, front support strap 6, and the rear support strap 28 (illustrated in FIG. 6).

The rack frame support braces 16 are located on a top of the rack frame 14 and provide stability to the rack frame 14, ensuring the sides of the rack frame 14 do not bend or sway from the weight of the forest fire pods 100.

The rack frame support braces 16 are permanently welded to the rack frame 14 main structure providing stability when the rack frame 14 is moved by maintenance crews or the like.

To ensure that the rack frame 14 that houses the forest fire pods 100 are secured to the deck of the aircraft, mounting point brackets 12 are used. These mounting point brackets 12 are welded to the bottom of the rack frame 14 in each corner thereof. The mounting point brackets 12 are configured to fit into quick release slots located on the deck of the aircraft.

When rack frames 14 are stored in a staging area, the mounting point brackets 12 act as legs for the rack frame 14 to rest on ground surfaces when not in an aircraft.

As illustrated in FIGS. 2-7, the forest fire pods 100 are to be housed and stored within the reinforced rack frame 14. As described herein, the rack frame 14 has four mounting point brackets 12 configured to secure the rack frame 14 to a deck of an aircraft cargo bay or storage area. The rack frame 14 has rack frame support braces 16 to provide strength and stability for the rack frame 14.

The rack frame 14 includes side conveyor track frames 13 disposed on both sides of the rack frame 14 that are mounting points for side gravity conveyor rollers 10. The side conveyor track frames 13 are provided to assist and guide forest fire pods 100 out of the rack frame 14.

The side conveyor track frames 13 is secured to the rack frame 14 by side conveyor bolts 11.

Mounted inside the side conveyor track frames 13 are side gravity conveyor rollers 10 that serve a similar purpose as bottom gravity conveyor rollers 20. The side conveyor track frames 13 works in conjunction with the bottom gravity conveyor rollers 20, to rapidly allow the forest fire pods to be deployed from an aircraft cargo bay to a forest fires below. The side conveyor track frames 13 add stability to the rack frame 14.

The side gravity conveyor rollers 10 are cylindrical wheels that are mounted along an axle, each side of the axle being mounted into each of the side conveyor track frames 13. The side gravity conveyor rollers 10 are configured to spin in alternate directions when the forest fire pods 100 are loaded or unloaded into the rack frame 14. This allows the forest fire pods 100 to be moved freely and quickly back and forth from inside the rack frame 14 to outside of the rack frame 14. The side gravity conveyor rollers 10 are cylindrical wheels that are mounted vertically to the side conveyor track frame 13 that is mounted by side conveyor bolts 11 on each side of the rack frame 14.

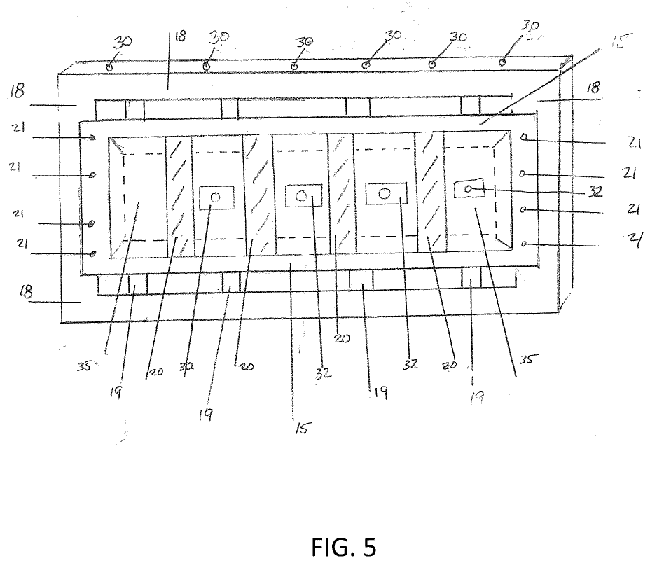

FIG. 5 illustrates a bottom view of the rack frame 14. Bottom conveyor support beams 19 provide a firm and level platform to help carry and support the weight of the bottom conveyor sled 15 and the forest fire pods 100 within the rack frame 14. Each bottom conveyor support beam 19 is welded directly to the sides of the bottom sled frame 18 that provide strength and stability for the entire rack frame 14 that houses the forest fire pods 100.

To aid maintenance crew in repairs, inspections and easy access to the rack frame 14, the bottom sled frame 18 is used. The bottom sled frame 18 acts as the central base that connects the sides of the rack frame 14 together into a stable unit. The bottom sled frame 18 is affixed to the rack frame 14 by bottom sled bolts 30.

These bottom sled bolts 30 allow the bottom sled frame 18 to be independently removed from the rack frame 14, during repair or to remove an item. Thus, if a damaged bottom sled frame 18 cannot be repaired, a new unit is installed instead of taking an entire rack frame 14 out of service.

The bottom sled frame 18 is the mounting base for the bottom conveyor sled 15. The bottom conveyor sled 15 is the resting base for the forest fire pods 100 at all times, even if they are empty. In order to safely move any forest fire pods 100 at anytime, especially when they are full, this action must be accomplished on the bottom conveyor sled 15. The bottom conveyor sled 15 is secured to the bottom sled frame 18 by sled mounting bolts 21. The sled mounting bolts 21 allows the bottom conveyor sled 15 to be easily removed for maintenance and repair. Attached to the bottom conveyor sled 15 are the mounting points for the bottom gravity conveyor rollers 20.

Each bottom gravity conveyor roller 20 is free spinning and able to smoothly move the heavy forest fire pods 100. The bottom gravity conveyor rollers 20 are so efficient that one maintenance crewman can move a forest fire pod 100 that is resting on the bottom conveyor sled 15.

The bottom gravity conveyor rollers 20 are constructed in a similar manner to the side gravity conveyor rollers 10. The bottom gravity conveyor roller 20 also help guide the forest fire pod 100 in and out of the rack frame 14 to be released or deployed off an aircraft. The bottom gravity conveyor rollers 20 are mounted to a bottom conveyor sled 15. The bottom conveyor sled 15 is bolted to the bottom sled frame 18 by sled mounting bolts 21. The bottom sled frame 18 is mounted to the rack frame 14 by bottom sled bolts 30. Bottom conveyor support beams 19 are installed to provide strength and stability to the bottom sled frame 18 and to provide a support structure for the bottom conveyor sled 15 to rest upon.

To aid in maintenance and repairs, the entire bottom sled frame 18 assembly is detachable from the rack frame 14 by removing the bottom sled bolts 30. Each rack frame 14 is secured to the floor, storage area or aircraft cargo bay by mounting point brackets 12. Though embodiments described herein use mounting bolts, other fastening means such as screws, nails, or other fasteners may be used, as appropriate, without deviating from the structure and purpose of the invention.

Attached to the bottom of the bottom conveyor sled 15 is the water drip tray 35. The water drip tray 35 collects water or liquids that may leak from the forest fire pods 100. Mounted to the bottom of the water drip tray 35 are electronic leak detection sensors 32. Each electronic leak detection sensor 32 will emit an audible alert and a red flashing light when water or liquids come in contact therewith.

To ensure the forest fire pods are protected against leaks, safety features have been installed. One feature includes multiple electronic leak detection sensors 32. These electronic leak detection sensors 32 are placed beneath the forest fire pods 100. When any of the forest fire pods 100 start to leak, the flow of water or fire retardant material over a certain threshold will trip the electronic leak detection sensors 32 and set off a 120 decibel alarm. The leak will also trigger a flashing red indicator light to promptly notify personnel of a potential damaged forest fire pod 100 in case the audible alarm is not heard. Maintenance crews will also receive real time alerts twenty-four hours a day, seven days a week from the electronic leak detections sensors 32 WIFI gateway, which monitors all sensors and instantly sends notifications and alerts to maintenance crew phones and to central control center.

The electronic leak detection sensors 32 are attached to a water drip tray that collects any leakage from the forest fire pods 100.

A second method of detecting leaks is leak detection tape 31. Each forest fire pod 100 has leak detection tape 31 attached to the outer sides thereof. In the event a leak above a predetermined threshold occurs on any of the forest fire pods 100, and the liquid comes in contact with the leak detection tape 31, the leak detection tape 31 instantly turns a bright red color, but embodiments are not limited thereto. The leak detection tape 31 may turn from grey to red, or from green to red when sufficient water or fire retardant material comes in contact with the leak detection tape 31. This makes it easier for maintenance crew to locate a leak quickly to determine what steps need to be taken to repair the leak.

FIG. 6 illustrates a back view of a rack frame in accordance with FIG. 3. Embodiments described herein may include a rear support strap 28 and mounting strap bolts 24. These mounting strap bolts 24 allow the unit to be quickly and easily removed or replaced if damaged. Attached to the rear support strap 28, and manufactured as one unit, is the rear tension stabilizer cushion 23.

The rear rack frame 22 secures all sides of the rack frame 14 into a structurally sound unit by being welded to the other sides of the rack frame 14. As described herein, attached to the rear rack frame 22, is the rear support strap 28. The rear support strap 28 helps secure the forest fire pods 100 inside the rack frame 14 during storage, filling, moving or maintenance. The rear support strap 28 is secured to the rear rack frame 22 by the mounting straps bolts 24.

The purpose of the rear tension stabilizer cushion 23 is to prevent wear and tear on the forest fire pods 100 outer cardboard multi-layered shell and keep the forest fire pod 100 taut and from moving around. The rear support strap 28 may be made of nylon, leather, or other suitable fabric or fabric-like material. The rear tension stabilizer cushion 23 may be made of foam, rubber, plastic, or suitable material as known in the art.

The rear tension stabilizer cushion 23 helps provide tautness needed to keep the forest fire pods 100 snug to each other. This snug fit is desired to prevent the forest fire pods 100 from bumping against each other to cause weak spots that could case leaks on the multi-layered shells 1 that could cause leaks or other damage.

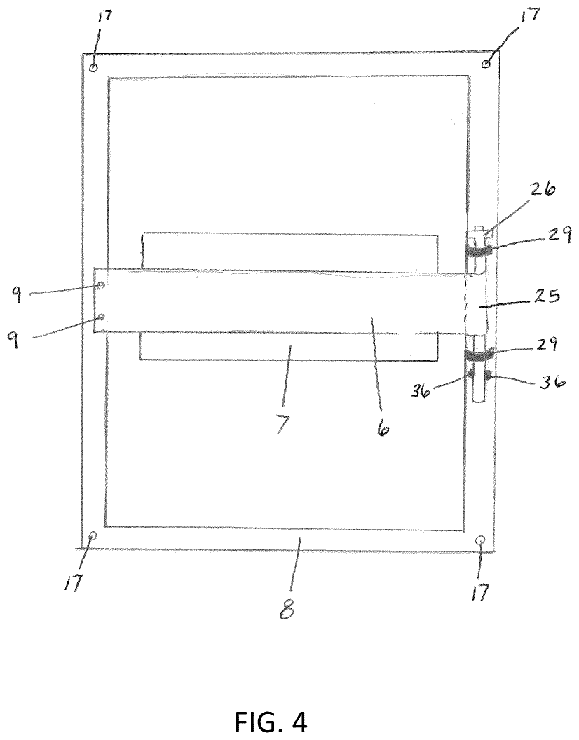

As illustrated in FIG. 4, a front rack door 8 is a metal frame that forms the entry point that allows the forest fire pods 100 to be accessed during service, maintenance and the opening to deploy the forest fire pods 100. The front rack door 8 is attached to the rack frame 14 by front frame bolts 17 to make maintenance and repairs easier.

As illustrated in FIGS. 1, 2, 3, 4 and 7, the rack frame 14 has a front rack door 8 configured to allow for the removal and replacement of one or more forest fire pods 100. The front rack door 8 should remain locked when one or more forest fire pods 100 are stored inside the rack frame 14. The front rack door 8 is mounted to the rack frame 14 by front frame bolts 17.

Embodiments described herein allow for one or more forest fire pods 100 to be loaded into the rack frame 14 at a given time. When a rack frame 14 is filled with forest fire pods 100, the forest fire pods 100 are ensured a snug fit. When one or more forest fire pods 100 are removed from inside the rack frame 14, one or more gaps are formed. These one or more gaps make the forest fire pods 100 in the racks frame 14 unstable and may cause damage to the forest fire pods 100. To maintain the tautness and snug fit desired for the configuration of forest fire pods 100, a hooked cargo strap may be used to ensure forest fire pods 100 are secure when a rack frame 14 is missing one or more forest fire pods 100. The hooked cargo strap is made of a durable woven nylon material with a metal hook at both ends. The side conveyor track frame 13 on both sides has metal cargo strap rings 40 at predetermined locations for securing the hooked cargo strap 39 to secure the forest fire pods 100 in place inside the rack frame 14. In such a case, one or more hooked cargo straps holds the forest fire pods 100 in place such that they will not slide about during transit. Such a setup may occur when not all of a set of forest fire pods 100 are deployed for a given event.

Attached to the front rack door 8 is the front support strap 6 that serves a similar purpose as the rear support strap 28. The front support strap 6 also has a front tension stabilizer cushion 7 that keeps the forest fire pods 100 inside the rack frame 14 snug and taut at all times, either empty or full inside the rack frame. The front support strap 6 is secured to the front rack door 8 by front mounting bolts 9 at one end of the front support strap 6. Attached to the other end of the front support strap 6, is a front slot eyelet 25. The front support strap 6 and the front slot eyelet 25 each may be made of nylon, leather, or other sturdy fabric or fabric-like material.

Also attached the front rack door 8 are metal eye loops 29. A front quick release pin 26 secures the front support strap 6 to the front rack door 8 by placing the front support strap 6 between the metal eye loops 29 and slide the front quick release pin 26 through them both. At the end of the front quick release pin 26, are locking balls 36, that retract when they are slid through the metal eye loops 29 and the front slot eyelet 25. Once the locking balls 36 pass through, the locking balls 36 pop back out locking the front quick release pins 26 below the metal eye loops 29. The front support strap 6 is locked and the forest fire pods 100 are secure inside the rack frame 14.

The rack frame 14 further includes a front tension stabilizer cushion 7 and front support strap 6. To help prevent movement and chafing of the forest fire pod 100, the front tension stabilizer cushion 7 is attached to the front support strap 6. At one end of the front support strap 6 are front mounting bolts 9 that secure the front support strap 6 to the front of the front rack door 8. At the other end of the front support strap 6 is a front slot eyelet 25 that allows the front quick release pin 26 to slide into. The front support strap 6 may be made of nylon or other suitable strap material as known in the art. The front tension stabilizer cushion 7 may be made of foam, rubber, plastic, or suitable material as known in the art

Attached to the front rack door 8 are metal eye loops 29. To properly secure the forest fire pods 1 into the rack frame 14, the front slot eyelet 25 are aligned between the two metal eye loops 29 and the front quick release pin 26 is slid through to secure the front support strap 6 to the front rack door 8. To ensure the front quick release pin 26 from detaching from the metal eye loops 29 are locking balls 36 that pops out to secure the front quick release pin 26 in place and secure. The front slot eyelet 25 may be made of nylon or other suitable strap material as known in the art.

In operation, the forest fire pods 100 that rupture on tree branches, will fall down on a fire from above saturating the trees and the ground as the forest fire pods 100 fall. This sequence is similar to that of a helicopter or aircraft water tanker when they release their payload on a forest fire.

However, forest fire pods 100 as described herein are different when they make contact with a fire and the ground.

When a forest fire pod 100 ruptures upon making contact with a fire on the ground, the forest fire pod 100 has built up a lot of downward momentum. The sheer weight of the forest fire pod 100 causes it to hit the ground with a much greater force than mere water or fire retardant being sprayed over a fire. This force causes the liquid inside to expand outward on the ground and force the water or fire retardant outwards in a substantially three hundred and sixty degree circular pattern. The force of the liquid spray from the impact of the forest fire pods 100 covers a radius in proportion to the height from which the forest fire pod is dropped, free of obstruction. The radial spray of a forest fire pods 100 may be from six feet to sixty feet, depending upon the release height and the size of the forest fire pods 100. When the forest fire pods 100 make contact with the ground, the spray from the forest fire pods 100 may spread out in a circular or overall pattern, or a wide pattern if first coming in contact with a tree or other obstacle.

As the force of the forest fire pods 100 liquid content moves outward, it momentarily separates the fire from its fuel source. It is at this point, that the ground and the fires fuel source becomes damp and wet.

These few seconds are crucial to stopping the progression of the fire from quickly reigniting. As more forest fire pods 100 are dropped within the same surrounding fire area, its liquid contents further wet the ground and trees to extinguish or slow the fire down from quickly reigniting.

An operation of filling an aircraft during a fire event with rack frames 14 and fire-fighting pods 100 will be described. As empty aircraft return to be refilled, forest fire pods 100 are strategically housed, filled while waiting personnel are ready to remove the empty rack frames 14 and slide new filled forest fire pods 100 and one or more rack frames 14 inside an aircraft's cargo bay area. Like a well-organized pit crew, the aircraft can be launched at a much faster rate than traditional fire-fighting systems because the empty rack frames 14 that carry the forest fire pods 100 are easily unlocked and slid out while new filled rack frames 14 are positioned to slide in and be secured in a matter of minutes. This process is made possible because the forest fire pods 100 can be stored in a staging area for quick access due to the fact they are already filled with fire retardant material and ready to go.

The capacity for each forest fire pod 100 holds may hold up to about 1,500 gallons of water or firefighting retardant material. The filled rack frames 14 can also be configured to hold more forest fire pods 100 when the rack frames 14 are bolted together from the rear of the rack frames. To further increase the forest fire pods capacity, the rack frames 14 may be bolted on top of each other depending upon an aircraft's cargo bay load capacity.

Once an aircraft is airborne, a pilot can fly the aircraft at a much safer and higher altitude over the fire than with traditional aircraft that merely carry loose water or fire retardant material. Because forest fire pods 100 are completely contained units, their content will not dissipate once they are released over a forest fire, unlike other methods that spray. When the fire has been located, forest fire pods 100 are released from the rack frame 14 located in the cargo bay area of the aircraft. The forest fire pods 100 are dropped for the purpose of slowing and controlling the spread of the fire.

The aircraft has the capability of carrying multiple rack frames 14 of forest fire pods 100. This allows an aircraft to make multiple passes over a forest fire releasing more forest fire pods 100 before the aircraft has to return to base to be refilled with more forest fire pods 100.

As illustrated FIGS. 1, 2, 3 and 7, the forest fire pods 100 are placed empty inside the one or more rack frames 14 and secured in place by front support strap 6 before they are filled. The tops of the forest fire pods 100 can be quickly identified by the fill port indicator 2 which denotes the fill port indicator and must be in this position at all times, even when empty or during storage and movement of the forest fire pods 100. The orientation is such that the fill port 27 may be properly placed to load the forest fire pods 100 with water or fire retardant liquid. Located in the center of the red band is the fill port 27. Through this opening is access to the liquid chamber 5 that stores water and firefighting retardant agents after the forest fire pods 100 are filled. The fill port plug 3 is covered with epoxy and pushed securely into the fill port 27. After being loaded into the rack frame 14, the forest fire pods 100 are now ready to be placed in storage or ready to be deployed to combat forest fires as needed. If the forest fire pods 100 are not immediately needed after being loaded and filled, they can be stored completely filled inside the rack frame 14 for a storage life of one to two years or more when forest fire pods 100 are stored in a dry and moist free storage area.

Embodiments described herein provide many advantages over traditional systems. Because forest fire pods 100 have a longer storage life and storage mechanism than other water and fire retardant sources, when a first aircraft takes off to combat a forest fire, another fully loaded aircraft with filled forest fire pods 100 may take off at predetermined intervals in order to continue to fight the forest fire. This early activity of pre-stored forest fire pods 100 has a time advantage from traditional helicopters and aircraft that have water tankers that must be filled and then deployed on a fire-fighting mission.

The foregoing is illustrative of embodiments and is not to be construed as limiting thereof. Although embodiments have been described, those skilled in the art will readily appreciate that many modifications are possible in the embodiments without materially departing from the novel teachings and features of the invention. Accordingly, all such modifications are intended to be included within the scope of the invention. Therefore, it is to be understood that the foregoing is illustrative of various embodiments and is not to be construed as limited to the specific embodiments disclosed, and that modifications to the disclosed embodiments, as well as other embodiments, are intended to be included within the scope of the invention, as set forth in the following claims and equivalents thereof.

1. A forest fire pod system, comprising:
a rack frame configured to hold a plurality of forest fire pods, the rack frame having a plurality of rollers to facilitate loading and unloading of the forest fire pods, wherein each forest fire pod includes:
a multi-layered shell including a plurality of bio-degradable and water resistant layers;
a fill port to capture an amount of fire retardant material; and
a fill port plug configured to seal the fill port and enable the forest fire pods to be stored for transit.

2. The system of claim 1, wherein the multi-layered shell includes layers including a polyvinyl alcohol polymer and a bio-degradable resin.

3. The system of claim 1, wherein the fill port is circular in cross-section.

4. The system of claim 1, wherein the forest fire pods are hexagonal shaped.

5. The system of claim 1, wherein the plurality of rollers includes a plurality of side gravity conveyor rollers disposed at sides of the rack frame.

6. The system of claim 1, wherein the plurality of rollers includes a plurality of bottom gravity conveyor rollers disposed adjacent a bottom of the rack frame.

7. The system of claim 6, wherein the plurality of bottom gravity conveyor rollers are disposed on a bottom conveyor sled, wherein the bottom conveyor sled is configured to receive and deploy the forest fighting pods.

8. The system of claim 1, wherein the rack frame includes a front rack door that forms an entry point to allow the forest fire pods to be accessed during service, maintenance, and deploying of the forest fire pods.
